(19) United States
(12) Patent Application Publication
(10) Pub. No.: US 2018/0234185 A1
(43) Pub. Date: Aug. 16, 2018

(54) MODE DIVISION MULTIPLEXED PASSIVE OPTICAL NETWORK

(71) Applicant: ASTON UNIVERSITY, Birmingham, West Midlands (GB)

(72) Inventors: Filipe FERREIRA, Birmingham, West Midlands (GB); Andrew ELLIS, Birmingham, West Midlands (GB); Naoise MAC-SUIBHNE, Birmingham, West Midlands (GB)

(73) Assignee: ASTON UNIVERSITY, Birmingham, West Midlands (GB)

(21) Appl. No.: 15/756,246

(22) PCT Filed: Jun. 24, 2016
(86) PCT No.: PCT/GB2016/051904

§ 371 Date: Feb. 28, 2018

(30) Foreign Application Priority Data
Jun. 26, 2015 (GB) 1511295.6

(51) Int. Cl. H04B 10/2507; H04J 14/04; H04B 10/2581; H04B 10/67

(52) U.S. Cl. CPC H04B 10/2572; H04B 10/672; H04B 10/2581; H04J 14/04

(57) ABSTRACT

A mode division multiplexing passive optical network (PON) in which channel estimation/inversion is performed in the optical domain. The PON comprises a plurality of input channels; a multiplexer having a plurality of input ports connected to a respective one of the input channels; an optical fibre having an uplink end connected to an output port of the multiplexer, whereby the multiplexer outputs a mode multiplexed signal corresponding to the optical signals from the plurality of input channels. The PON includes an optical equalizer arranged to transfer power between optical signals having different modes to compensate for crosstalk between the different modes. In this system, compensation for crosstalk occurs in the optical domain, e.g. by using the optical equalizer to adapt the optical signals where necessary.

### FIELD OF THE INVENTION

The invention relates to a passive optical network. In particular, the invention relates to a mode division multiplexed passive optical network in which a few mode fibre (FMF) is used to convey optical signals that are selectively delivered to a plurality of end users.

### BACKGROUND TO THE INVENTION

Mode division multiplexing (MDM) technology is a potential next-generation solution to improve the capacity of optical access networks in a cost-effective way and to provide backward compatibility with legacy standard single-mode fibre optic networks. In theory, an N-fold capacity increase can be obtained by using a few-mode fibre (FMF) to guide N independent modes. However, there are two effects seen in FMFs which impair the signal and need to be addressed in order to reach full capacity. These effects are (i) linear modal coupling (crosstalk), and (ii) differential mode delay. On long distance applications, the interplay between these effects typically requires the use of a coherent receiver in order to enable their mitigation through digital signal processing (DSP).

The basic architecture 100 of a known MDM passive optical network (PON) for supporting 6 modes (LP01, LP11a, LP11b, LP21a, LP21b, LP02) is shown in FIG. 1. At an input (transmitter) side there are six optical line terminations (OLTs) 102, which are located in the same facility (often referred to as a Central Office (CO)). At an output (receiver) side, there are six optical network units (ONUs) 104, which are typically distributed in different physical locations.

Each OLT is connected to a transmitter side mode multiplexer 106 by a respective single mode fibre (SMF) 108. The mode multiplexer combines the signals from the OLTs 102 and transmits them on a few mode fibre (FMF) 110. At the receiver side, a mode demultiplexer 112 extracts each relevant signal and outputs to each respective ONU 104 via a respective single mode fibre 114.

The system in FIG. 1 introduces new impairments to the transmitted signal that are not encountered in single mode fibre passive optical networks, namely:
the mode multiplexer 108 and mode demultiplexer 112 can introduce a non-negligible amount of crosstalk;
the FMF 110 can introduce different differential mode delay and different crosstalk levels between different pairs of linearly polarized (LP) modes.

For pairs of non-degenerate LP modes, such as LP01 and LP11a or LP01 and LP11b, the crosstalk strength can be as low as −40 dB/km (e.g. −27 dB at the end of 20 km), but the differential mode delay can be as high as 1000 ps/km. In contrast, for pairs of degenerate LP modes, for example LP11a and LP11b or LP21a and LP21b, the crosstalk strength is much higher such that full mixing can be achieved after a couple of tens of kilometres but the differential mode delay can be lower than 1 ps/km.

The different effects for degenerate and non-degenerate modes can be understood by considering the transfer matrix for the FMF 110. A FMF can be modelled as N sections, where each section is modelled by one unitary matrix XT introducing the crosstalk and one diagonal matrix DMD whose diagonal elements introduce the mode delay. FIG. 2 shows an example of these matrices for the ith section of an FMF.

In general, the fibre matrix H_{FMF}(ω)=XT₁DMD₁ . . . XT_{N}DMD_{N} is dependent on the frequency whenever the differential mode delay is non-negligible. Since this is the case in general for pairs of non-degenerate LP modes, the full fibre matrix is dependent on frequency.

In known MDM techniques, channel estimation/inversion is usually done in the electrical domain after detecting the modes all together. However, in the architecture described in FIG. 1, the modes are detected independently, which means it is impractical or impossible to use a DSP at the receiver end. This means channel estimation/inversion must be done at the transmitter end if this detection technique is to be used.

Channel estimation at the CO requires the communication/cooperation between the OLTs (enabled by the backplane) and upstream transmission of pilot signals (which must be different for each mode). In this way, different OLTs will receive different combinations of the pilot signals, which when combined allow for the estimation of the channel matrix and consequent pre-compensation. However, disadvantages of this arrangement include lack of backward compatibility and the requirement for expensive coherent receivers.

### SUMMARY OF THE INVENTION

At its most general, the present invention proposes a technique for channel estimation/inversion in the optical domain. It is anticipated that the invention will be particularly effective in short distance applications, where the impact of the interplay between crosstalk and differential mode delay can be tolerated to some extent and mitigated in the optical domain without the use of a DSP. The invention allows for full backward compatibility concerning OLTs and ONUs.

According to the invention, there is provided a mode division multiplexing passive optical network comprising: a plurality of input channels, each of the plurality of input channels (e.g. optical line terminals (OLTs)) being arranged to convey an optical signal in a different one of a plurality of modes (e.g. differently linearly polarised modes); an optical transfer unit comprising: a multiplexer having a plurality of input ports and an output port, wherein each of the plurality of input ports is connected to a respective one of the plurality of input channels; an optical fibre (e.g. a few mode fibre) having an uplink end connected to the output port, wherein the optical fibre is arranged to receive from the multiplexer a mode multiplexed signal corresponding to the optical signals from the plurality of input channels; a demultiplexer having an input port and a plurality of output ports, wherein the input port is connected to a downlink end of the optical fibre, and wherein the demultiplexer is arranged to divide the mode multiplexed signal between each of the plurality of output ports; a plurality of output channels (e.g. corresponding to or connected to optical network units (ONUs)), each of the plurality of output channels being connected to a respective one of the plurality of output ports and being arranged to convey an optical signal in a different one of the plurality of modes conveyed by the plurality of input channels; and an optical equalizer arranged to transfer power between optical signals having different modes to compensate for crosstalk between the different modes. In this system, compensation for crosstalk occurs in the optical domain, e.g. by using the optical equalizer to adapt the optical signals where necessary.

The optical equalizer may be used to compensate both uplink and downlink signals. Thus, the optical equalizer may be present both at the input channels and at the output channels. on the input channels before transmission across the optical transfer unit. The optical equalizer may be combined with the multiplexer and/or demultiplexer or it may be a standalone component.

The network can include a controller arranged to control the optical equalizer based on a crosstalk characteristic of the optical transfer unit. The crosstalk characteristic can be represented by a transfer matrix that takes into account both crosstalk and differential mode delay. Preferably, the crosstalk characteristic is based on an assumption that crosstalk between each pair of degenerate modes in the plurality of modes occurs predominantly only between that pair of degenerate modes. In addition, the crosstalk characteristic may be based on an assumption that the crosstalk from non-degenerate modes is negligible and that the differential time delay between degenerate modes is very small. On this basis, the optical equalizer can be arranged only to compensate optical signals on input channels and/or output channels that are arranged to convey optical signals in degenerate modes.

The network may include a detector arranged to detect a pilot signal transmitted by the optical transfer unit in each degenerate mode in the plurality of modes, wherein the controller is arranged to control the optical equalizer based on the detected pilot signal in conjunction with the crosstalk characteristic. In other words, the behaviour of the pilot signal may be indicative of the crosstalk characteristic, and therefore settings for the optical equalizer may be derivable by the controller from the detected pilot signal.

The optical equalizer may be arranged to control a magnitude and phase of an optical signal corresponding to at least one of each pair of degenerate mode as it is coupled into the input channels and/or output channels of the modes to which it exhibits crosstalk. Thus, if the crosstalk characteristic indicates that crosstalk occurs only between degenerate pairs of modes, then the optical equalizer may have a 2×2 configuration in which each pair of degenerate modes output from the optical transfer unit (multiplexer or demultiplexer) are both coupled to both input channels or output channels for conveying one of those degenerate modes. The optical equalizer may control the magnitude and phase of one of the degenerate modes. This signal may be understood to be a compensating signal for the optical signal that is eventually conveyed by the respective input channel or output channel.

The optical equalizer may comprise a butterfly FIR filter arranged to generate each respective compensating signal.

The multiplexer and demultiplexer may be designed to introduce negligible crosstalk. However, in one embodiment, the optical equalizer may be arranged to compensate for crosstalk between the different modes introduced by the multiplexer and/or the demultiplexer, e.g. by introducing an N×N configuration in which each mode output from the optical transfer unit is coupled into each of the plurality of input channels and/or output channels respectively.

The pilot signal may be introduced into each channel that conveys a degenerate mode. For example, an optical source may be coupled to introduce the pilot signal to each of the plurality of input (or output) channels that is arranged to convey an optical signal in a degenerate mode. Alternatively, a modulator may be provided on each of the plurality of input (or output) channels that is arranged to convey an optical signal in a degenerate mode, wherein the modulator is arranged to introduce the pilot signal by varying the phase or intensity of the optical signal conveyed by its respective input channel.

### BRIEF DESCRIPTION OF THE DRAWINGS

Examples of the inventions are discussed below with reference to the accompanying drawings, in which:

FIG. 1 is a schematic diagram of a known architecture for a mode division multiplexing passive optical network (MDM-PON), which is discussed above;

FIG. 2 is an illustration of section I of a fibre model transfer matrix, also discussed above;

FIG. 3 is a schematic diagram of an MDM-PON architecture that is an embodiment of the present invention;

FIG. 4 shows a plurality of graphs which compare different aspects of system performance with and without compensation;

FIG. 5 is a graph showing error free bandwidth as function of crosstalk;

FIG. 6 is a schematic diagram showing configurations for a multiplexer and a demultiplexer suitable for use with the invention;

FIG. 7 is a schematic diagram showing configurations for an optical FIR filter suitable for use with the invention; and

FIG. 8 illustrates pilot signal generation schemes suitable for use with the invention.

### DETAILED DESCRIPTION; FURTHER OPTIONS AND PREFERENCES

The present invention is based on the recognition that, in typical FMFs, the differential mode delay between degenerate modes is usually very low (˜1 ps/km). This means that matrix terms of XTᵢ relating these modes (e.g. relating LP11a and LP11b or LP21a and LP21b) have a low dependency on the frequency. These terms are primarily responsible for the introduction of crosstalk as explained above. In the invention, we propose the mitigation of crosstalk by compensating only for crosstalk taking place between degenerate modes, i.e. the terms highlighted in boxes 201, 202, 203, 204 in FIG. 2. Compensating signals can be controlled using a one-tap optical equalizer.

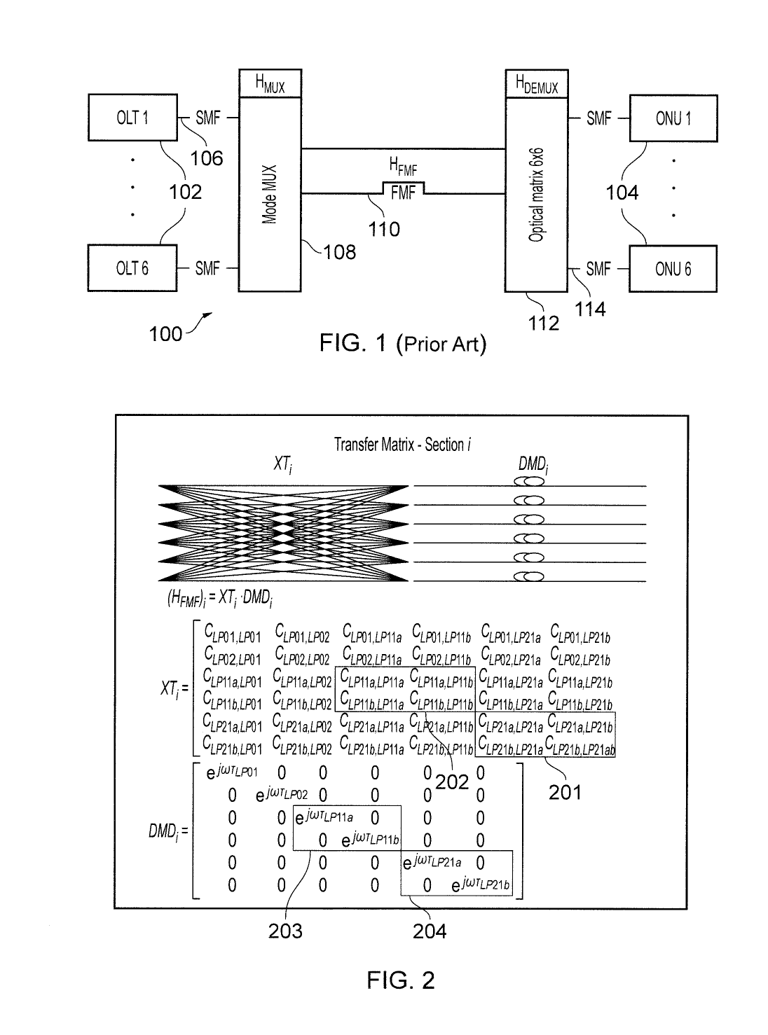

The crosstalk characteristics of the mode multiplexer 108 and mode demultiplexer 112 shown in FIG. 1 can be described by a respective unitary matrices (e.g. H_{MUX} and H_{DEMUX}). After inversion, these matrices can be used to fully compensate for the mode mixing. However, by appropriate design of the mode multiplexer 108 and mode demultiplexer 112 known to a skilled person, the crosstalk introduced between non-degenerate LP modes can be reduced to less than −20 dB, which means it can be treated as negligible for the purposes of the invention. In this case, only the crosstalk between degenerate LP modes needs to be compensated.

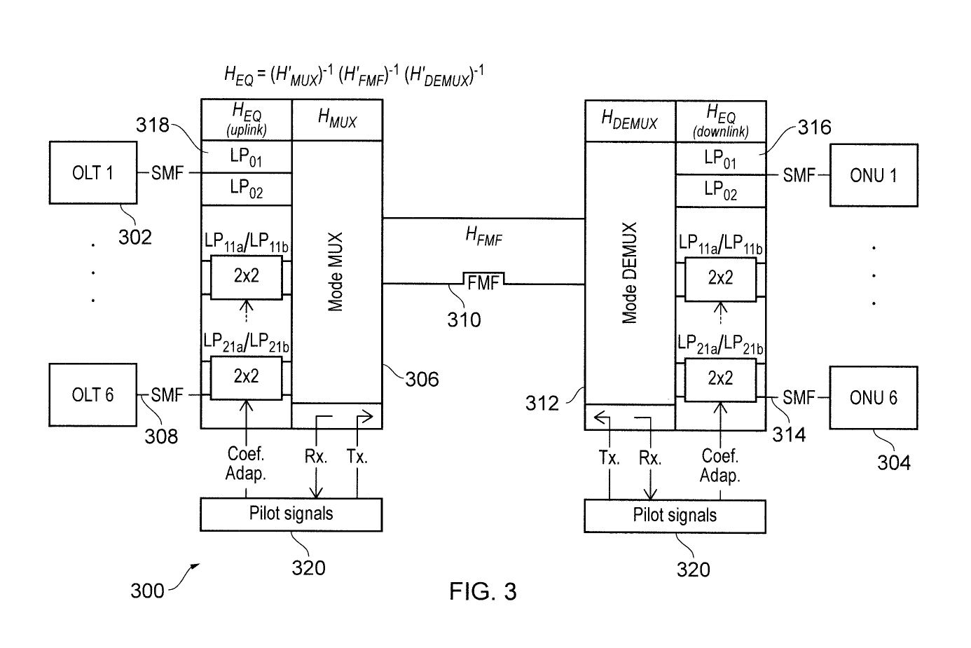

FIG. 3 shows an architecture 300 for a mode division multiplexing passive optical network that is an embodiment of the invention.

Similarly to FIG. 1, architecture 300 shows is for supporting 6 modes (LP01, LP11a, LP11b, LP21a, LP21b, LP02), but the invention need not be limited to this. At an input (transmitter or uplink) side there are six optical line terminations (OLTs) 302, which are located in a Central Office. At an output (receiver or downlink) side, there are six optical network units (ONUs) 304, which are distributed in different physical locations.

Each OLT is connected to a mode multiplexer 306 by a respective single mode fibre (SMF) 308. The mode multiplexer 306 combines the signals from the OLTs 302 and transmits them on a few mode fibre (FMF) 310. At the receiver side, a mode demultiplexer 312 extracts each relevant signal and outputs to each respective ONU 304 via a respective single mode fibre 314.

In this architecture, channel estimation/inversion is implemented by a downlink optical equalizer 316 next to the mode demultiplexer 312 for the downlink and by an uplink optical equalizer 318 next to the mode multiplexer 306 for the uplink, although the invention need not be limited to this arrangement. For example, both channel estimation/inversion processes may be located in the mode multiplexer 306.

The downlink optical equalizer 316 and the uplink optical equalizer 318 are arranged to partially compensate for the crosstalk introduced by the mode multiplexer 306, the FMF 310 and the mode demultiplexer 312 using two optical butterfly finite impulse response (FIR) filters. The phrase “partially compensate” refers to the idea of directing compensation at the degenerate modes only.

As explained above, the differential mode delay between pairs of degenerate modes is very low and they exchange power preferentially between themselves. This allows the fibre transfer matrix to be approximated as:

$${H}_{FMF}^{′} = {XT}_{1}^{′} {DMD}_{1}^{′} … {XT}_{i}^{′} {DMD}_{i}^{′} … {XT}_{N}^{′} {DMD}_{N}^{′} \\ where \\ {XT}_{i}^{′} = [ \begin{matrix}1 & 0 & 0 & 0 & 0 & 0 \\ 0 & 1 & 0 & 0 & 0 & 0 \\ 0 & 0 & {C}_{LP 11 a , LP 11 a} & {C}_{LP 11 a , LP 11 b} & 0 & 0 \\ 0 & 0 & {C}_{LP 11 b , LP 11 a} & {C}_{LP 11 b , LP 11 b} & 0 & 0 \\ 0 & 0 & 0 & 0 & {C}_{LP 21 a , LP 21 a} & {C}_{LP 21 a , LP 21 b} \\ 0 & 0 & 0 & 0 & {C}_{LP 21 b , LP 21 a} & {C}_{LP 21 b , LP 21 b}\end{matrix} ] \\ and \\ {DMD}_{i}^{′} = [ \begin{matrix}{e}^{j {ωτ}_{LP 01}} & 0 & 0 & 0 & 0 & 0 \\ 0 & {e}^{j {ωτ}_{LP 02}} & 0 & 0 & 0 & 0 \\ 0 & 0 & {e}^{j {ωτ}_{LP 11}} & 0 & 0 & 0 \\ 0 & 0 & 0 & {e}^{j {ωτ}_{LP 11}} & 0 & 0 \\ 0 & 0 & 0 & 0 & {e}^{j {ωτ}_{LP 21}} & 0 \\ 0 & 0 & 0 & 0 & 0 & {e}^{j {ωτ}_{LP 21}}\end{matrix} ] \\ and \\ {τ}_{LP 11} \approx {τ}_{LP 11 a} \approx {τ}_{LP 11 b} \\ {τ}_{LP 21} \approx {τ}_{LP 21 a} \approx {τ}_{LP 21 b} \qquad ( 1 )$$

According to (1), two optical butterfly FIR filters can be configured to output an equalizing response H_{EQ} that describes the crosstalk between degenerate LP modes, where

H_{EQ}=(H_{MUX})⁻¹(H′_{FMF})⁻¹(H_{MUX})⁻¹.

Regarding the pairs of non-degenerate modes, the differential mode delay can be very high, thereby it would not be possible to compensate their coupling with one tap, but because the crosstalk strength is low, it can be tolerated without compensation.

The butterfly FIR filters act to couple signals to each pair of degenerate modes to rebalance the power between them in order to compensate for crosstalk effects discussed above. The FIR filters coefficients are adapted using pilot signals 320 received at the mode demultiplexer 312 and the mode multiplexer 306. The pilot signals may be transmitted at the mode demultiplexer 312 and the mode multiplexer 306 or at the OLTs/ONUs 302, 304.

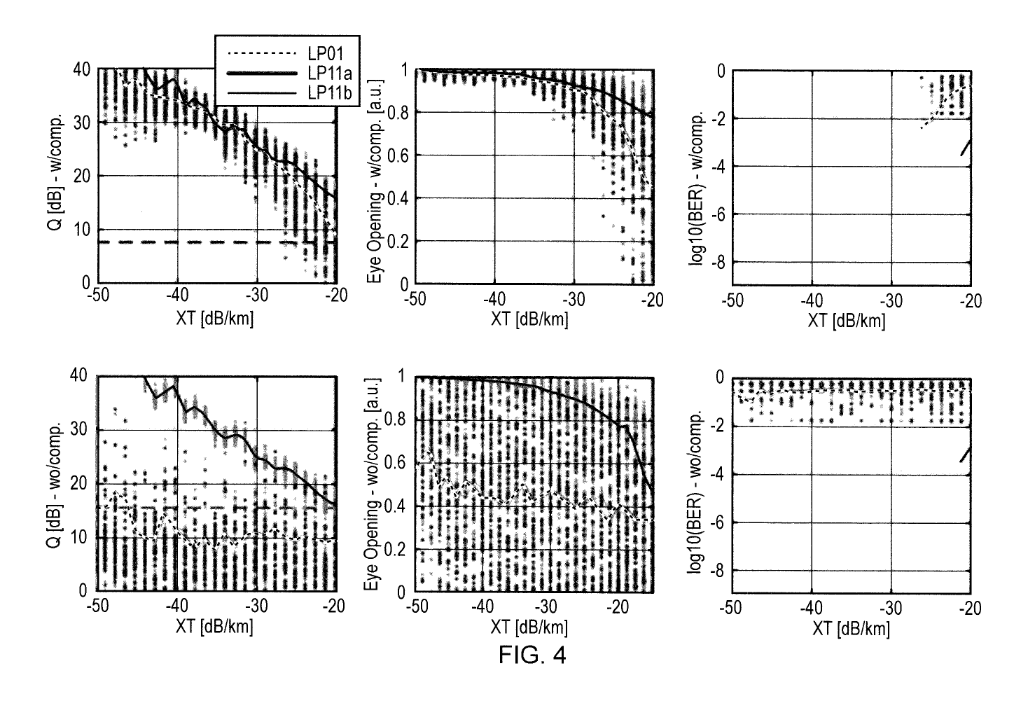

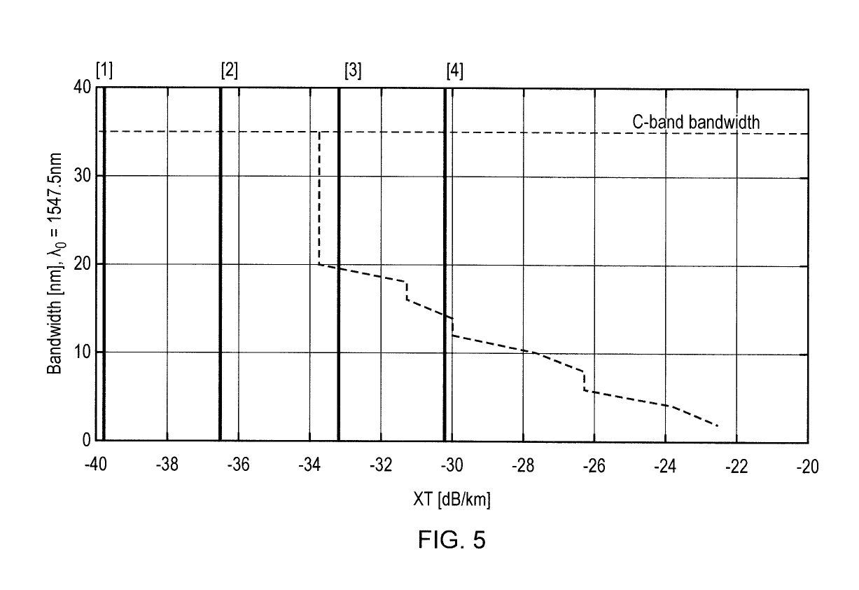

FIGS. 4 and 5 represent the results of tests performed on a simulated model of an arrangement similar to that shown in FIG. 3, where the MDM system is arranged to support 3 modes (LP01, LP11a, LP11b), to enable a plurality of 10 Gbps intensity modulated direct detected (IM/DD) systems (one per mode) to operate independently of one another.

In the simulation, the crosstalk introduced by the fibre was varied from −40 dB/km to −15 dB/km, and the mode multiplexer and mode demultiplexer were each assumed to introduce −20 dB crosstalk. The FMF was assumed to introduce a differential mode delay of 1000 ps/km between each pair of non-degenerate modes (LP01 and LP11a/b) and 1 ps/km between the degenerate modes (LP11a and LP11b). Finally, in order to assess the frequency dependency of the fibre transfer matrix coefficients, the estimation was done at 1547.5 nm and the 10 Gbps IM/DD channels were transmitted at a different wavelength that was varied from 1530 nm to 1565 nm.

FIG. 4 presents two rows of three graphs. The top row of graphs shows the Q-factor, the eye opening and the bit error rate (BER) respectively when compensation is applied. The bottom row of graphs show the same parameters without compensation. These graphs are calculated based on a 3 nm wavelength separation between the channel wavelengths and the estimation wavelength. Similar graphs result for both positive and negative wavelength shifts around the estimation wavelength.

The results in FIG. 4 show that, considering a 3 nm detuning, the compensation method proposed allows for error free transmission for FMFs presenting a crosstalk lower than −25 dB/km. in other words, such FMFs allow for efficient crosstalk mitigation over a 10 nm bandwidth around 1547 nm with only two butterfly FIR filters.

FIG. 5 shows the error free bandwidth as function of the FMF crosstalk. The results show that for a fibre presenting a crosstalk strength as high as −25 dB/km (a high value according to the literature) the method proposed would be able to compensate the crosstalk between the degenerate modes over 5 nm. On the other hand, for a fibre with a crosstalk around −34 dB/km, the method proposed would be able to compensate the crosstalk between the degenerate modes over 32 nm (i.e. the whole extended C-band).

According to Table 1 below, FMFs can be designed to support 6 modes with a crosstalk equal to −30.21 dB/km. Taking into considering such crosstalk value, FIG. 5 shows that the proposed system (at least for 3 modes) would allow error free performance over 14 nm using only two butterfly FIR filters.

TABLE 1
Properties of several FMFs presented in the literature

| | XT | LP | Refractive- | |
|---|---|---|---|---|
| Fibre | [dB/km] | modes | Index Profile | Reference |
| [1] | −39.77 | 3 | Graded-Index | L. Grüner-Nielsen, et al., |
| | | | | J. Lightw. Technol., 30(23), |
| | | | | p. 3693, 2012. |
| [2] | −36.53 | 3 | Step-Index | A. Li, et al., Proc. |
| | | | | OFC′2011, p. PDPB8. |
| [3] | −33.19 | 3 | Graded-Index | R. Ryf, et al., J. Lightw. |
| | | | | Technol., 30(4), p. 521, |
| | | | | 2012. |
| [4] | −30.21 | 6 | Graded-Index | T. Mori, et al., Proc. |
| | | | | OFC′2013, p. OTh3K.1. |

If the MDM-PON is required to support a broader bandwidth (e.g. if it is given a high number of WDM channels), the system bandwidth can be duplicated to 28 nm using two pairs of butterfly filters operating in different wavelengths (14 nm apart). Similarly, if the mode demultiplexer 312 and the mode multiplexer 306 introduce higher crosstalk than −20 dB, it may be necessary to use a 6×6 optical FIR filter to provide the necessary compensation.

A practical implementation of the arrangement shown in FIG. 3 is discussed below.

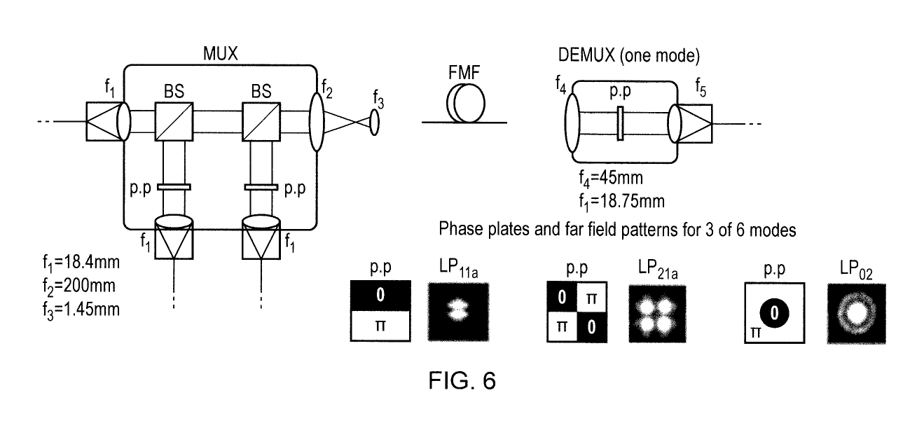

FIG. 6 illustrates a free-space optics configuration for a mode selective multiplexer and a mode selective demultiplexer implemented using phase plates. The invention need not be limited to this set up. For example, optimised photonic lanterns may be used to guarantee mode selective operation.

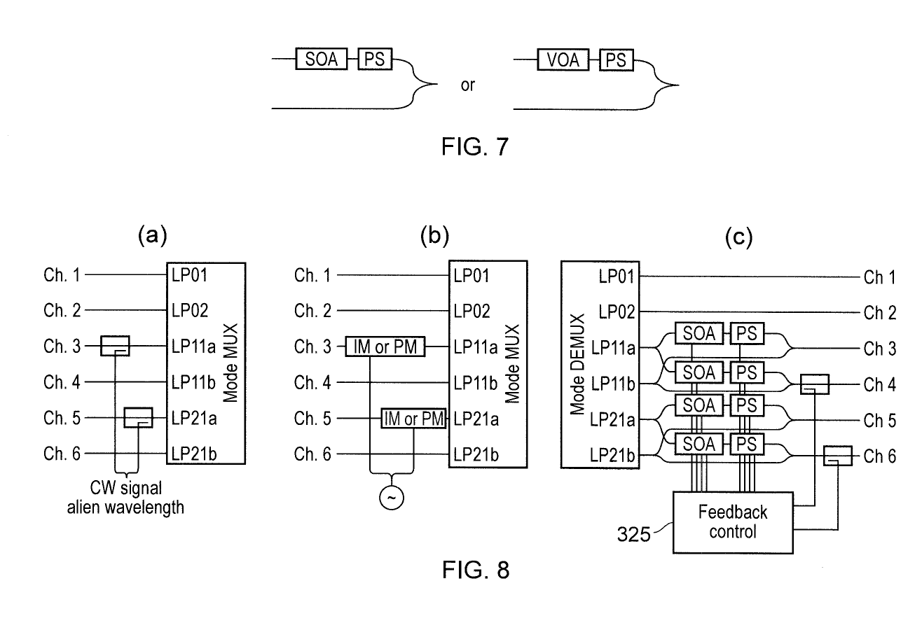

FIG. 7 shows two possible arrangements for the optical butterfly FIR filters. Thus, the butterfly FIR filters can be assembled using an integrated all-optical switch based on a Mach-Zehnder interferometer (MZI), using a variable optical amplifier (VOA) or a semiconductor optical amplifier (SOA) and a phase shifter (PS).

FIG. 8 shows different types of pilot signal/tone schemes that can be used with the invention. FIG. 8 shows schemes for introducing pilot signals at the mode multiplexer input for detection at the mode demultiplexer output for the downlink. It can be understood that a similar arrangement in reverse can be provided for the uplink.

In FIG. 8(a) a CW carrier (having a different wavelength) is added to the data carriers. The CW carrier is introduced at the mode multiplexer, only at the LP11a mode port and at the LP21a mode port. At the mode demultiplexer output ports, the CW carriers at the LP11b and LP21b ports are filtered out after a high ratio tap and directly detected using a low-speed detector, e.g. as shown in FIG. 8(c). The detector output is used by a feedback loop circuit 325 to command the butterfly coefficients.

FIG. 8(b) shows a scheme for pilot tone generation using a phase modulator or intensity modulator. Here, a low frequency pilot tone will be added to the data carriers in LP11a and LP11b using a phase modulator or amplitude modulator at the mode multiplexer input. At the mode demultiplexer output ports, the data carriers at the LP11b and LP21b output ports are detected after a high ratio tap, allowing for the detection and extraction of the pilot tones, as shown in FIG. 8(c). The power of the extracted pilot tones is used by the feedback loop circuit 325 to command the butterfly coefficients.

Alternatively, instead of relying on pilot tones/signals, the data carriers at the LP11b and LP21b output ports of the mode demultiplexer can be fully received locally, such that the eye opening can be used to command the butterfly coefficients.

The invention discussed above may presents two main advantages. Firstly it offers full backward compatibility regarding already installed OLTs, ONUs, and fibre installed therebetween. Secondly it relies on a reduced number of simple optical components in a non-complex setup, allowing for mass production at low cost.

Moreover, the invention is advantageous for manufacturers of passive optical networks, since it allows the capacity of a network to be increased by a given number of modes (equal or higher than 3) through the installation of a single fibre between the central office and supply locations, and without requiring existing components or fibres to be removed.

1. A mode division multiplexing passive optical network comprising:
a plurality of input channels, each of the plurality of input channels being arranged to convey an optical signal in a different one of a plurality of modes;
an optical transfer unit comprising:
a multiplexer having a plurality of input ports and an output port, wherein each of the plurality of input ports is connected to a respective one of the plurality of input channels;
an optical fiber having an uplink end connected to the output port, wherein the optical fiber is arranged to receive from the multiplexer a mode multiplexed signal corresponding to the optical signals from the plurality of input channels;
a demultiplexer having an input port and a plurality of output ports, wherein the input port is connected to a downlink end of the optical fiber, and wherein the demultiplexer is arranged to divide the mode multiplexed signal between each of the plurality of output ports;
a plurality of output channels, each of the plurality of output channels being connected to a respective one of the plurality of output ports and being arranged to convey an optical signal in a different one of the plurality of modes conveyed by the plurality of input channels; and
an optical equalizer arranged to transfer power between optical signals having different modes to compensate for crosstalk between the different modes.

2. The mode division multiplexing passive optical network according to claim 1 including a controller arranged to control the optical equalizer based on a crosstalk characteristic of the optical transfer unit.

3. The mode division multiplexing passive optical network according to claim 2, wherein the crosstalk characteristic is based on an assumption that crosstalk between each pair of degenerate modes in the plurality of modes occurs predominantly only between that pair of degenerate modes.

4. The mode division multiplexing passive optical network according to claim 3 including a detector arranged to detect a pilot signal transmitted by the optical transfer unit in each degenerate mode in the plurality of modes, wherein the controller is arranged to control the optical equalizer based on the detected pilot signal in conjunction with the crosstalk characteristic.

5. The mode division multiplexing passive optical network according to claim 3, wherein the optical equalizer is arranged to set a magnitude and phase of a compensating signal that forms part of the optical signal conveyed by the optical transfer unit in each degenerate mode in the plurality of modes.

6. The mode division multiplexing passive optical network according to claim 5, wherein the optical equalizer is arranged to set the magnitude and phase of the compensating signal based on a control signal from the controller.

7. The mode division multiplexing passive optical network according to Claim 5, wherein the optical equalizer comprises a butterfly FIR filter arranged to generate each respective compensating signal.

8. A mode division multiplexing passive optical network according to Claim 1, wherein the optical equalizer is connected between the plurality of output ports of the demultiplexer and the plurality of output channels to perform downlink crosstalk compensation.

9. The mode division multiplexing passive optical network according to claim 8 including a second optical equalizer connected between the plurality of input channels and the plurality of input ports of the multiplexer to perform uplink crosstalk compensation.

10. The mode division multiplexing passive optical network according to Claim 1, wherein the optical equalizer is connected between the plurality of input channels and the plurality of input ports of the multiplexer to perform uplink crosstalk compensation.

11. The mode division multiplexing passive optical network according to Claim 1, wherein the optical equalizer is arranged to compensate for crosstalk between the different modes introduced by the multiplexer and/or the demultiplexer.

12. The mode division multiplexing passive optical network according to claim 4 including an optical source coupled to introduce the pilot signal to each of the plurality of input channels that is arranged to convey an optical signal in a degenerate mode.

13. The mode division multiplexing passive optical network according to Claim 4 including a modulator on each of the plurality of input channels that is arranged to convey an optical signal in a degenerate mode, wherein the modulator is arranged to introduce the pilot signal by varying the phase or intensity of the optical signal conveyed by its respective input channel.
